(19) United States
(12) Patent Application Publication
(10) Pub. No.: US 2017/0013430 A1
(43) Pub. Date: Jan. 12, 2017

(54) USER CLASSIFICATION METHOD, APPARATUS, AND SERVER

(71) Applicant: TENCENT TECHNOLOGY (SHENZHEN) COMPANY LIMITED, Shenzhen (CN)

(72) Inventor: Jie DONG, Shenzhen (CN)

(73) Assignee: TENCENT TECHNOLOGY (SHENZHEN) COMPANY LIMITED, Shenzhen (CN)

(21) Appl. No.: 15/262,810

(22) Filed: Sep. 12, 2016

Related U.S. Application Data
(63) Continuation of application No. PCT/CN2015/074184, filed on Mar. 13, 2015.

(30) Foreign Application Priority Data
Mar. 13, 2014 (CN) 201410092785.X

(51) Int. Cl. H04W 4/20; H04L 29/08

(52) U.S. Cl. CPC H04W 4/206; H04L 67/306; H04L 67/22; H04L 67/34

(57) ABSTRACT

Embodiments provide a user classification method, apparatus, and server. The method is applied to the server, the server performs data communication with multiple terminal devices, and a same application is installed on the multiple terminal devices. The method includes: acquiring a function type information sequence uploaded by each terminal device, where one group of function type information sequence corresponds to one terminal device, function type information in each of the function type information sequences is arranged in an order of triggering functions of an application installed in a corresponding terminal device, and one piece of function type information is generated after one function of the application is triggered; determining a user corresponding to each of the function type information sequences; and classifying users corresponding to a same function type information sequence as same-class users, to form multiple user classes.

### CROSS-REFERENCE TO RELATED APPLICATIONS

This application is a continuation of International Application No. PCT/CN2015/074184, filed on Mar. 13, 2015, which claims the priority to Chinese Patent Application No. 201410092785.X, filed on Mar. 13, 2014, each of which are incorporated herein by reference in their entirety.

### FIELD OF THE TECHNOLOGY

The present disclosure relates to the field of data processing technologies, and in particular, to a user classification method, apparatus, and server.

### BACKGROUND

With the development of the Internet, especially the rapid development of the mobile Internet, the number of Internet users is increasing exponentially. Based on a large Internet user group, service providers provide more and more Internet applications (such as instant messaging software and mobile phone assistant software), and in order to ensure operation quality of the Internet applications, the service providers often update the Internet applications according to features of the users, so as to improve functions of the Internet applications. Therefore, for adjustment of design quality and operation quality of an Internet application, data analysis may be performed on data operated by a user in the Internet application.

Currently, when data analysis is performed on the data operated by the user on the Internet application, a massive amount of user data would be classified according to a user class, so as to determine user data in different user classes. When user class classification is performed for a massive amount of user data, a used classical algorithm includes: an unsupervised classification algorithm (Kmeans algorithm), a decision tree algorithm, or a naive Bayesian algorithm.

The inventor of the present disclosure finds in a process of implementing the present disclosure that: currently, when a massive amount of user data is classified according to a user class, the number of user classes of a used algorithm, such as the Kmeans algorithm, the decision tree algorithm, or the naive Bayesian algorithm is manually and randomly set in advance. However, the randomly set number of the user classes may not accurately represent the number of all user classes, resulting that user class classification performed on the massive amount of user data is very inaccurate. It can be seen that, it is desirable to provide a user classification method, so thaclassified user classes can cover user classes as completely as possible.

### SUMMARY

The present disclosure provides a user classification method, apparatus, and server, so as to solve a problem in an existing algorithm that the number of used user classes is set manually and randomly in advance, and may not accurately represent the number of all user classes.

A user classification method is applied to a server, the server performing data communication with multiple terminal devices, and a same application being installed on the multiple terminal devices; the method including:

acquiring a function type information sequence uploaded by each terminal device, one group of function type information sequence corresponding to one terminal device, function type information in each of the function type information sequences being arranged in an order of triggering functions of an application installed in a corresponding terminal device, and one piece of function type information being generated after one function of the application is triggered;

determining a user corresponding to each of the function type information sequences; and

classifying users corresponding to a same function type information sequence as same-class users, to form multiple user classes.

In another aspect, a user classification apparatus is applied to a server, the server performing data communication with multiple terminal devices, and a same application being installed on the multiple terminal devices; and the apparatus including:

an acquiring module, configured to acquire a function type information sequence uploaded by each terminal device, one group of function type information sequence corresponding to one terminal device, function type information in each of the function type information sequences being arranged in an order of triggering functions of an application installed in a corresponding terminal device, and a piece of function type information being generated after a function of the application is triggered;

a determining module, configured to determine a user corresponding to each of the function type information sequences; and

a classification module, configured to classify users corresponding to a same function type information sequence as same-class users, to form multiple user classes.

A server includes the user classification apparatus described above.

In the user classification method provided in the disclosed embodiments, multiple terminal devices, on which a same application is installed, that can perform data communication with a server separately upload a function type information sequence to the server, where one group of function type information sequence corresponds to one terminal device, and function type information in each of the function type information sequences is arranged in an order of triggering functions of an application installed in a corresponding terminal device; after a user corresponding to each of the function type information sequences is determined, users corresponding to a same function type information sequence can be classified as same-class users, and multiple user classes are formed, so as to complete user classification. The number of user classes determined in the user classification method provided in the embodiments is classified according to a function type information sequence combined by application functions operated by a user according to a time sequence, and users corresponding to a same function type information sequence are classified as same-class users, and therefore, a classified user class indicates an operational requirement of users for a same application function, so that the classified user class is very accurate, thereby ensuring a subsequent accurate user data analysis.

### BRIEF DESCRIPTION OF THE DRAWINGS

To describe the technical solutions in the embodiments or more clearly, the following briefly introduces the accompanying drawings required for describing the embodiments. The accompanying drawings in the following description show only some embodiments, and a person of ordinary skill in the art may still derive other drawings from these accompanying drawings.

FIG. 1 is a network topology diagram of a user classification system according to an embodiment;

FIG. 2 is another network topology diagram of a user classification system according to an embodiment;

FIG. 3 is a flowchart of a user classification method according to an embodiment;

FIG. 4 is a flowchart of a method of acquiring function type information sequences uploaded by terminal devices according to an embodiment;

FIG. 5 is a structural block diagram of a user classification apparatus according to an embodiment o;

FIG. 6 is a structural block diagram of an acquiring module according to an embodiment;

FIG. 7 is another structural block diagram of an acquiring module according to an embodiment;

FIG. 8 is a structural block diagram of a first receiving unit according to an embodiment;

FIG. 9 is a structural block diagram of a third receiving unit according to an embodiment;

FIG. 10 is another structural block diagram of a first receiving unit according to an embodiment;

FIG. 11 is another structural block diagram of a third receiving unit according to an embodiment;

FIG. 12 is another structural block diagram of a user classification apparatus according to an embodiment;

FIG. 13 is still another structural block diagram of a first receiving unit according to an embodiment;

FIG. 14 is still another structural block diagram of a third receiving unit according to an embodiment;

FIG. 15 is still another structural block diagram of a user classification apparatus according to an embodiment;

FIG. 16 is yet another structural block diagram of a user classification apparatus according to an embodiment; and

FIG. 17 is a structural block diagram of hardware of a server according to an embodiment.

### DESCRIPTION

The following embodiments are described with reference to the accompanying drawings. The described embodiments are some rather than all of the embodiments. All other embodiments obtained by a person of ordinary skill in the art based on the disclosed embodiments shall fall within the protection scope of the claims.

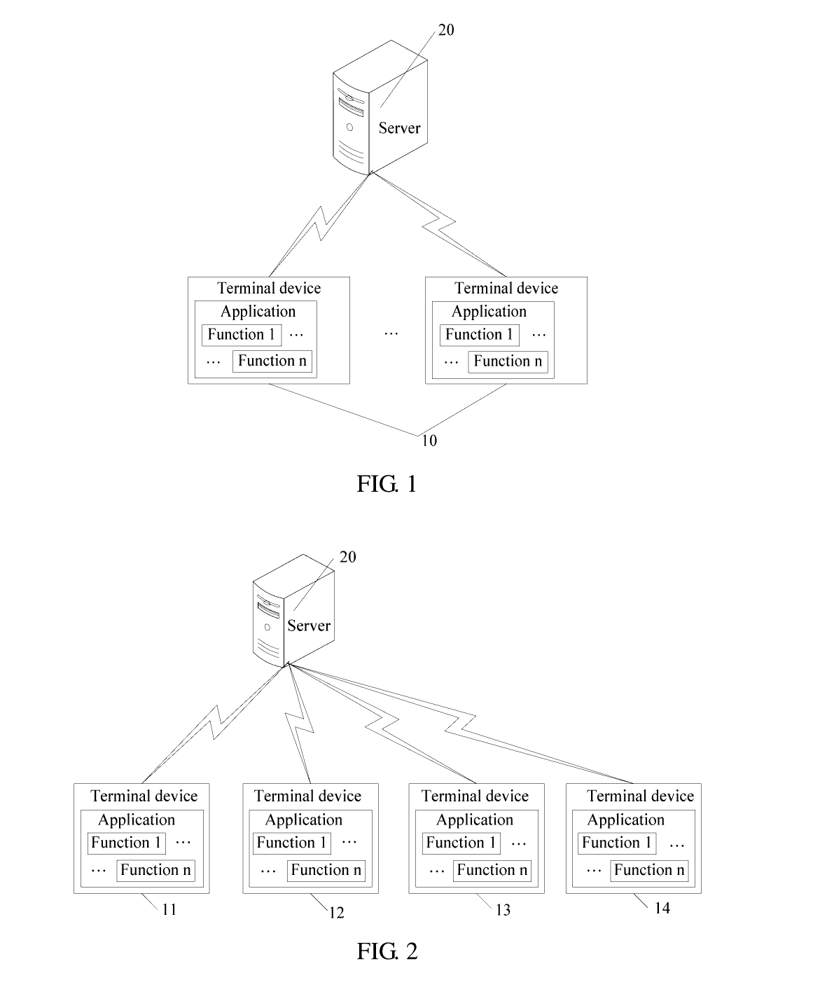

FIG. 1 is a network topology diagram of a user classification system according to an embodiment. Referring to FIG. 1, the system may include: multiple terminal devices 10 and a server 20.

A same application program is installed on multiple terminal devices 10. The installed application has multiple functions that can be operated by a user, which are a function 1 to a function n that are shown in FIG. 1. The functions can be triggered and executed through an operation of the user. In an aspect, using an example in which the application is used as an instant messaging application, the instant messaging application is installed on each of the multiple terminal devices 10, the instant messaging application provides multiple functions that can be operated by the user, such as a chat function, an image uploading function, a video function, and a voice function.

Optionally, one terminal device can correspond to one user, different users can be distinguished by using user identifiers, and the user identifier may be a user account of an application used by the user, or may be an identifier of the terminal device.

In this embodiment, a time period in which the user performs an operation is set, and in the time period, if a function of the application installed in the terminal device is triggered and executed, the terminal device uploads function type information of the triggered function to the server 20, where the function type information is a basis for distinguishing multiple functions of the application, and different functions have different function type information. For example, function type information corresponding to the chat function may be chatting, and function type information corresponding to the video function may be a video. Function type information of different functions may also be distinguished by using different character identifiers; for example, function type information corresponding to the chat function may be 1, and function type information corresponding to the video function may be 2.

It can be seen that, during the time period in which the user performs an operation, the terminal device uploads one group of function type information sequence to the server 20. In the sequence, the function type information is arranged in an order of triggering the functions of the application installed in the terminal device. For example, in the time period in which the user performs the operation, a function 1, a function 3, the function 1, a function 4, and a function 5 of an application installed in the terminal device are successively triggered and executed, the terminal device uploads function type information of the function 1 to the server when the function 1 is triggered, for ease of description, the function type information is set to 1, and the terminal device uploads function type information 3 to the server when the function 3 is triggered by analogy. Therefore, in the entire time period in which the user performs the operation, the terminal device uploads one group of function type information sequence (1, 3, 1, 4, 5) to the server, and the function type information in the sequence is arranged in an order of triggering functions of the application. Optionally, in the time period in which the user performs the operation, the terminal device may further upload the user identifier to the server, so as to indicate a user to which the uploaded group of function type information sequence belongs.

In the time period in which the user performs an operation, the terminal device may also record the function type information according to a time sequence of triggering the functions of the application, and after the time period in which the user performs the operation is ended, combine the recorded function type information into a function type information sequence, and therefore upload the function type information sequence to the server.

The server 20 may be one or one group of independently operated servers. Because each of the terminal devices uploads the function type information sequence to the server 20, the server may obtain multiple groups of function type information sequences uploaded by the multiple terminal devices, where one group of function type information sequence may correspond to one terminal device. After collecting the multiple groups of the function type information sequences, the server may classify users having a same function type information sequence into one class, that is, users corresponding to a same function type information sequence are same-class users. For ease of description, it is assumed that there are 4 terminal devices, which are a terminal device 11, a terminal device 12, a terminal device 13, and a terminal device 14 respectively corresponding to a user 1, a user 2, a user 3, and a user 4, as shown in FIG. 2. If in the time period in which the user performs an operation, a function type information sequence uploaded by the terminal device 11 is (1, 2, 3, 4, 5), a function type information sequence uploaded by the terminal device 12 is (1, 2, 3, 4, 1), a function type information sequence uploaded by the terminal device 13 is (1, 2, 3, 4, 5), and a function type information sequence uploaded by the terminal device 14 is (1, 2, 3, 4, 1), the user 1 and the user 3 that have the same function type information sequence (1, 2, 3, 4, 5) are classified as same-class users, and the user 2 and the user 4 that have the same function type information sequence (1, 2, 3, 4, 1) are classified as same-class users, so as to complete classification for users.

After the user classification is completed, a corresponding data analysis application may be performed based on the user classification, for example, feature data (such as a user age, a geographical location, and a time for using the application) of same-class users may be acquired, so that a rule of the feature data of the same-class users is acquired, and characteristic information of the same-class users is found, so as to adjust application design quality and operation quality.

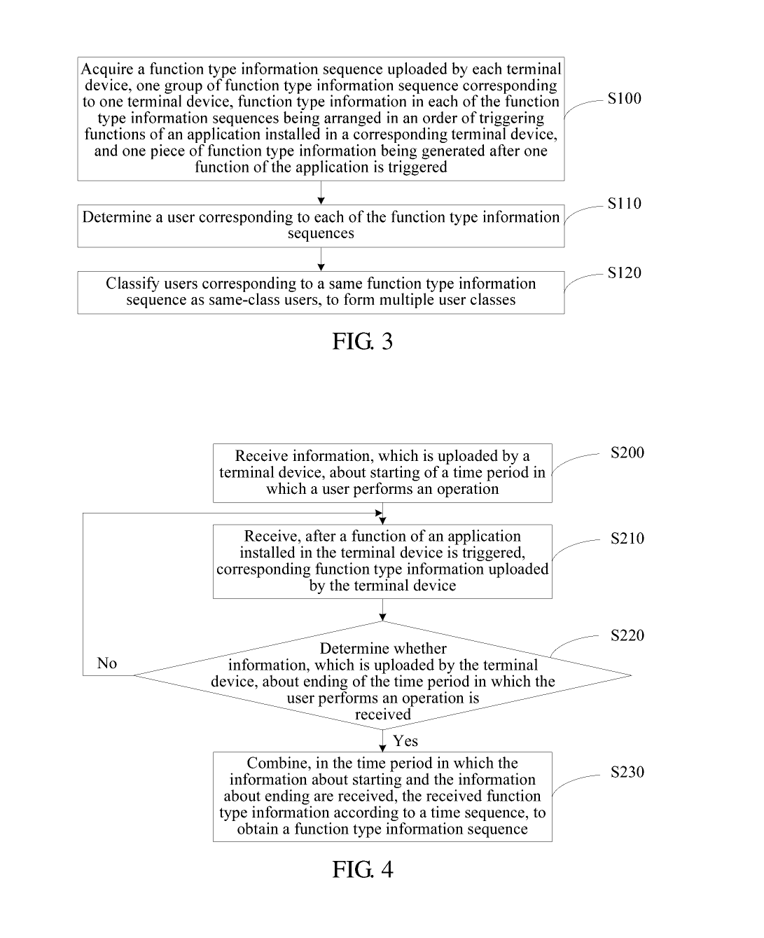

With reference to the foregoing description, the user classification method in this embodiment is described below from the perspective of the server. FIG. 3 is a flowchart of a user classification method according to an embodiment. The method may be applied to a server, the server may perform data communication with multiple terminal devices, and a same application is installed on the multiple terminal devices. Referring to FIG. 3, the method may include:

Step S100: Acquire a function type information sequence uploaded by each terminal device, one group of function type information sequence corresponding to one terminal device, function type information in each of the function type information sequences being arranged in an order of triggering functions of an application installed in a corresponding terminal device, and one piece of function type information being generated after one function of the application is triggered.

Step S110: Determine a user corresponding to each of the function type information sequences.

Optionally, the server may determine, by using a user identifier uploaded by the terminal device, a user corresponding to each sequence, for example, establish a correspondence between a function type information sequence and a user identifier that are uploaded by a same terminal device, so as to determine the user corresponding to the function type information sequence. The user identifier may be an identifier of the terminal device, or may be a user account when the user uses the application.

Step S120: Classify users corresponding to a same function type information sequence as same-class users, to form multiple user classes.

In the user classification method, multiple terminal devices, on which a same application is installed, that can perform data communication with a server separately upload a function type information sequence to the server, where one group of function type information sequence corresponds to one terminal device, and function type information in each of the function type information sequences is arranged in an order of triggering functions of the application installed in a corresponding terminal device; after a user corresponding to each of the function type information sequences is determined, users corresponding to a same function type information sequence can be classified as same-class users, and multiple user classes are formed, so as to complete user classification. The number of user classes determined in the user classification method provided in this embodiment is classified according to a function type information sequence combined by application functions operated by a user according to a time sequence, and users corresponding to a same function type information sequence are classified as same-class users, and therefore, a classified user class indicates an operational requirement of users for a same application function, so that the classified user class is very accurate, thereby ensuring a subsequent accurate user data analysis.

Optionally, the time period in which the user performs an operation is set. In the time period, a sequence combined by function type information corresponding to functions of an application triggered by the user according to a time sequence is a function type information sequence acquired by a server. Optionally, the terminal device may successively upload, to the server, the function type information corresponding to the functions of the application triggered in the time period, that is, in the time period, the functions of the application are triggered once, and the terminal device uploads the function type information corresponding to the triggered functions to the server, so that the server successively acquires multiple pieces of function type information according to the time sequence, implementing acquisition of the function type information sequence. The terminal device may also record, according to the time sequence, the function type information corresponding to the functions of the application triggered in the time period, combine the function type information into a function type information sequence, and upload the combined function type information sequence to the server, so that the server directly acquires the function type information sequence.

FIG. 4 is a flowchart of an optional method for acquiring function type information sequences uploaded by terminal devices according to an embodiment. The method may include:

Step S200: Receive information, which is uploaded by a terminal device, about starting of a time period in which a user performs an operation.

The information about starting may be information that is sent by the terminal device to a server when the terminal device determines that a current moment is a start moment of the time period in which the user performs an operation, to notify the server that the time period in which the user performs an operation starts from the start moment.

Step S210: Receive, after a function of an application installed in the terminal device is triggered, corresponding function type information uploaded by the terminal device.

Step S220: Determine whether information, which is uploaded by the terminal device, about ending of the time period in which the user performs an operation is received, if yes, perform step S230, and if not, perform step S210.

The information about ending may be information that is sent by the terminal device to a server when the terminal device determines that a current moment is an end moment of the time period in which the user performs an operation, to notify the server that the time period in which the user performs an operation is ended at the end moment. When the information about ending is not received, the server continuously receives function type information uploaded by the terminal device.

Step S230: Combine, in the time period in which the information about starting and the information about ending are received, the received function type information according to a time sequence, to obtain a function type information sequence.

Optionally, a manner in which the server acquires the function type information sequences uploaded by the terminal devices may further be: recording, by the terminal device according to the time sequence when determining the start moment of the time period in which the user performs an operation, the function type information corresponding to the triggered function of the application; combining, by the terminal device when determining the end moment of the time period in which the user performs an operation, the function type information recorded according to a time sequence in the time period from the start moment to the end moment, to obtain the function type information sequence; and uploading, by the terminal device, the obtained function type information sequence to the server, so that the server acquires the function type information sequence.

Any one of the foregoing manners of acquiring the function type information sequence uploaded by the terminal device involves the determining of the time period in which the user performs an operation. How to determine the time period when the user performs an operation is described below in detail.

Optionally, when displaying an application operation interface, the terminal device may display an option of starting to perform an operation and an option of ending performing an operation. When the option of starting to perform an operation is triggered by the user, the terminal device may determine that the current moment is the start moment of the time period in which the user performs an operation; and when the option of ending performing an operation is triggered by the user, the terminal device may determine that the current moment is the end moment of the time period in which the user performs an operation. It can be seen that, a time period from when the option of starting to perform an operation is triggered by the user, to when the option of ending performing an operation is triggered by the user is the time period in which the user performs an operation.

Correspondingly, when the option of starting to perform an operation is triggered by the user, the terminal device may send, to the server, information about starting of the time period in which the user performs an operation so that the server receives the information about starting, and determines that the time period in which the user performs an operation starts from the start moment; and when the option of ending performing an operation is triggered by the user, the terminal device may send, to the server, information about ending of the time period in which the user performs an operation, so that the server receives the information about ending, and determines that the time period in which the user performs an operation is ended at the end moment. In the time period in which the user performs the operation, the terminal device may successively upload the function type information to the server according to a time sequence of triggering the functions, so that the server acquires the function type information sequence.

In an aspect, when the option of starting to perform an operation is triggered by the user, the terminal device may record the function type information according to the time sequence of triggering the functions, and when the option of ending performing the operation is triggered by the user, the terminal device combines the recorded function type information into a function type information sequence, and uploads the function type information sequence to the server, so that the server acquires the function type information sequence.

The foregoing manner of determining the time period in which the user performs an operation has explicit information about ending an operation by the user, and for a situation in which there is no explicit information about ending an operation by the user, this embodiment also provides a manner of determining the time period in which the user performs an operation.

For the situation in which there is no explicit information about ending an operation by the user, a moment at which the user ends an operation needs to be, and an optional manner of determining the moment at which the user ends an operation may be that: after the start moment of the time period in which the user performs an operation is determined, a preset first time is reached, and it is automatically considered that the moment of ending the operation by the user is reached, that is, duration of the time period in which the user performs the operation is the preset first time. Correspondingly, the start moment of the time period in which the user performs an operation may be determined as follows: when the option of starting to perform an operation is triggered by the user, the terminal device may determine that the current moment is the start moment of the time period in which the user performs an operation; or, after a time of triggering the functions of the application last time reaches the preset first time, a moment at which the functions of the application are triggered for the first time is the start moment.

In this embodiment, the preset first time may be determined in the following manner setting a value of X; counting a total number of the function type information sequences acquired by the server when X is used as the preset first time; counting a total number of the function type information sequences acquired by the server when X+N is used as the preset first time, where N is a duration progressive value; calculating the total number of the function type information sequences acquired when X is used as the preset first time, and a deviation rate of the total number of the function type information sequences acquired when X+N is used as the preset first time; calculating a squared value of the deviation rate; if the squared value is not greater than a preset first value, determining that the set value of X is a value of the preset first time; and if the squared value is greater than the preset first value, increasing the value of X according to a set gradient ascent rule, and determining that a corresponding value of X is the value of the preset first time, until the squared value obtained through calculation is not greater than the preset first value.

Correspondingly, when the option of starting to perform the operation is triggered by the user, or after the time of triggering the functions of the application last time reaches the preset first time, when the functions of the application are triggered for the first time, the terminal device may send, to the server, information about starting of the time period in which the user performs an operation, so that the server receives the information about starting, and determines that the time period in which the user performs an operation starts from the start moment; and when the preset first time after the time period in which the user performs an operation is reached, the terminal device may send, to the server, the information about ending of the time period in which the user performs an operation, so that the server receives the information about ending, and determines that the time period in which the user performs an operation is ended at the end moment. In the time period in which the user performs an operation, the terminal device may successively upload the function type information to the server according to a time sequence of triggering the functions of the application, so that the server acquires the function type information sequence.

When the option of starting to perform an operation is triggered by the user, or after a time during which the function of the application is triggered last time reaches the preset first time, when the function of the application is triggered for the first time, the terminal device may record the function type information according to the time sequence of triggering the functions; and when the preset first time is reached after the time period in which the user performs the operation starts, the terminal device may combine the recorded function type information into a function type information sequence, and upload the function type information sequence to the server, so that the server acquires the function type information sequence.

For a situation in which there is no explicit information about ending an operation by the user, another optional manner of determining a moment at which the user ends an operation is that: after one function of the application is triggered, if no next function of the application is triggered in a preset second time, it is determined that the time period in which the user performs an operation is ended. Correspondingly, the start moment of the time period in which the user performs an operation may be determined as follows: when the option of starting to perform the operation is triggered by the user, the terminal device may determine that the current moment is an start moment of the time period in which the user performs the operation; or, after the time of triggering the functions of the application last time exceeds the preset second time, a moment at which the functions of the application are triggered for the first time is the start moment.

The preset second time may be determined in the following manner setting a value of A; counting a total number of the function type information sequences acquired by the server when A is used as the preset second time; counting a total number of the function type information sequences acquired by the server when A+n is used as the preset second time, where n is a duration progressive value; calculating the total number of the function type information sequences acquired when A is used as the preset second time, and a deviation rate of the total number of the function type information sequences acquired when A+n is used as the preset second time; calculating a squared value of the deviation rate; if the squared value is not greater than a preset second value, determining that the set value of A is a value of the preset second time; and if the squared value is greater than the preset second value, increasing the value of A according to a set gradient ascent rule, and determining that a corresponding value of A is the value of the preset second time, until the squared value obtained through calculation is not greater than the preset second value.

Correspondingly, when the option of starting to perform an operation is triggered by the user, or after the time of triggering the functions of the application last time exceeds the preset second time, when the functions of the application are triggered for the first time, the terminal device may send, to the server, information about starting of the time period in which the user performs an operation, so that the server receives the information about starting, and determines that the time period in which the user performs the operation starts from the start moment; and when one function of the application is triggered, and no next function of the application is triggered in the preset second time, the terminal device may send, to the server, the information about ending of the time period in which the user performs an operation, so that the server receives the information about ending, and determines that the time period in which the user performs an operation is ended at the end moment. In the time period in which the user performs an operation, the terminal device may successively upload the function type information to the server according to a time sequence of triggering the functions, so that the server acquires the function type information sequence.

When the option of starting to perform an operation is triggered by the user, or after a time during which the function of the application is triggered last time exceeds the preset second time, when the function of the application is triggered for the first time, the terminal device may record the function type information according to the time sequence of triggering the functions; and when one function of the application is triggered, and no next function of the application is triggered in the preset second time, the terminal device may combine the recorded function type information into a function type information sequence, and upload the function type information sequence to the server, so that the server acquires the function type information sequence.

Optionally, a manner of classifying users corresponding to a same function type information sequence as same-class users may be: if a current user class is 0, using any acquired function type information sequence as a standard of a user class, matching another acquired function type information sequence with the standard, adding a user corresponding to a function type information sequence matching the standard to the class to which the standard belongs, and using a function type information sequence not matching the standard as a standard of another user class; and if the current user class is not 0, matching any acquired function type information sequence with a function type information sequence corresponding to an existing user class, if any acquired function type information sequence matches the function type information sequence corresponding to the existing user class, adding a user corresponding to the acquired function type information sequence into the matched user class, and if any acquired function type information sequence does not match the function type information sequence corresponding to the existing user class, using the acquired function type information sequence as a standard of another user class.

Optionally, after multiple user classes are determined, feature data of same-class users may be acquired, so as to determine characteristic information of users of different classes.

The user classification apparatus is described below from the perspective of the server. The user classification apparatus described below and the user classification method described above may be cross-referenced correspondingly.

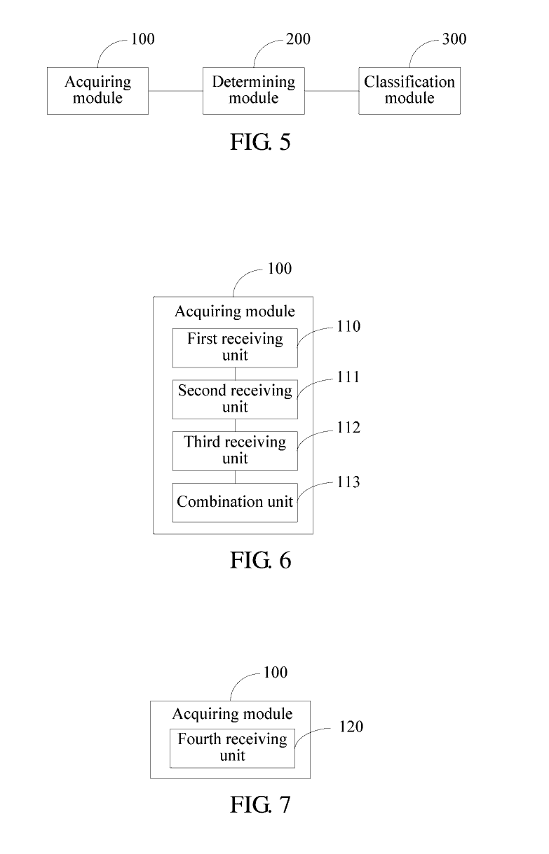

FIG. 5 is a structural block diagram of a user classification apparatus. The user classification apparatus may be applied to a server, the server may perform data communication with multiple terminal devices, and a same application is installed on the multiple terminal devices. The apparatus may include:

an acquiring module 100, configured to acquire a function type information sequence uploaded by each terminal device, one group of function type information sequence corresponding to one terminal device, function type information in each of the function type information sequences being arranged in an order of triggering functions of an application installed in a corresponding terminal device, and one piece of function type information is generated after one function of the application is triggered;

a determining module 200, configured to determine a user corresponding to each of the function type information sequences; and

a classification module 300, configured to classify users corresponding to a same function type information sequence as same-class users, to form multiple user classes.

Optionally, FIG. 6 shows an optional structure of the acquiring module 100. Referring to FIG. 6, the acquiring module 100 may include:

a first receiving unit 110, configured to receive information, which is uploaded by the terminal device, about starting of a time period in which a user performs an operation, where one operation performed by the user corresponds to triggering of one function of the application;

a second receiving unit 111, configured to receive, after the function of the application installed in the terminal device is triggered, corresponding function type information uploaded by the terminal device;

a third receiving unit 112, configured to receive information, which is uploaded by the terminal device, about ending of the time period in which the user performs the operation; and

a combination unit 113, configured to combine, in the time period in which the information about starting and the information about ending are received, the received function type information according to a time sequence, to obtain the function type information sequence.

Optionally, FIG. 7 shows another optional structure of the acquiring module 100. Referring to FIG. 7, the acquiring module 100 may include:

a fourth receiving unit 120, configured to receive a combined function type information sequence uploaded by the terminal device, where a process in which the terminal device combines the function type information sequence includes: recording, by the terminal device according to a time sequence when determining a start moment of the time period in which the user performs an operation, the function type information corresponding to the triggered function of the application, and combining, when an end moment of the time period in which the user performs an operation is determined, the function type information recorded according to the time sequence in the time period from the start moment to the end moment, to obtain the function type information sequence, where one operation performed by the user corresponds to triggering of one function of the application.

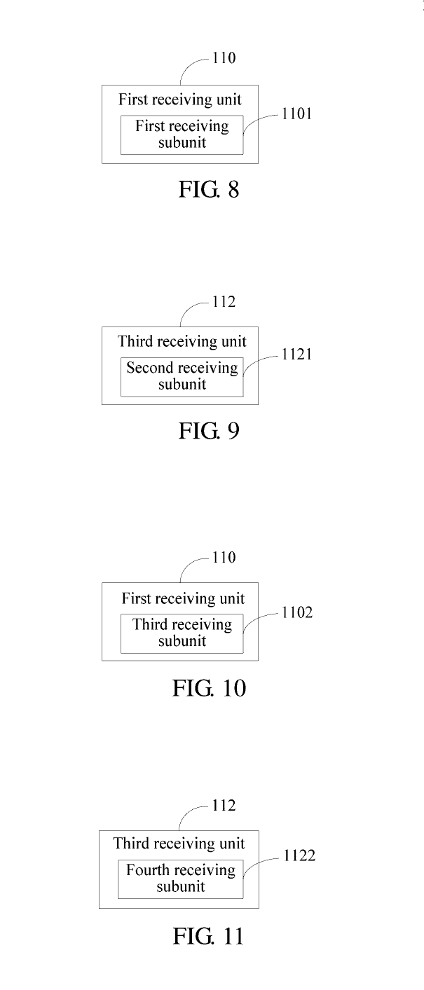

Optionally, FIG. 8 shows an optional structure of the first receiving unit 110. The first receiving unit 110 may include:

a first receiving subunit 1101, configured to receive, when an option, which is presented by the terminal device to the user, of starting to perform the operation is triggered by the user, the information, which is sent by the terminal device, about starting of the time period in which the user performs the operation.

Correspondingly, FIG. 9 shows an optional structure of the third receiving unit 112. The third receiving unit 112 may include:

a second receiving subunit 1121, configured to receive, when an option, which is presented by the terminal device to the user, of ending performing the operation is triggered by the user, the information, which is sent by the terminal device, about ending of the time period in which the user performs the operation.

Optionally, FIG. 10 shows another optional structure of the first receiving unit 110. Referring to FIG. 10, the first receiving unit 110 may include:

a third receiving subunit 1102, configured to receive, when an option, which is presented by the terminal device to the user, of starting to perform the operation is triggered by the user, the information, which is sent by the terminal device, about starting of the time period in which the user performs the operation; or, receive, when the function of the application is triggered for the first time and after a time during which the function of the application is triggered last time reaches a preset first time, the information, which is sent by the terminal device, about starting of the time period in which the user performs the operation.

Correspondingly, FIG. 11 shows another optional structure of the third receiving unit 112. The third receiving unit 112 may include:

a fourth receiving subunit 1122, configured to receive, when the preset first time is reached after the time period in which the user performs an operation starts, the information, which is sent by the terminal device, of ending of the time period in which the user performs the operation.

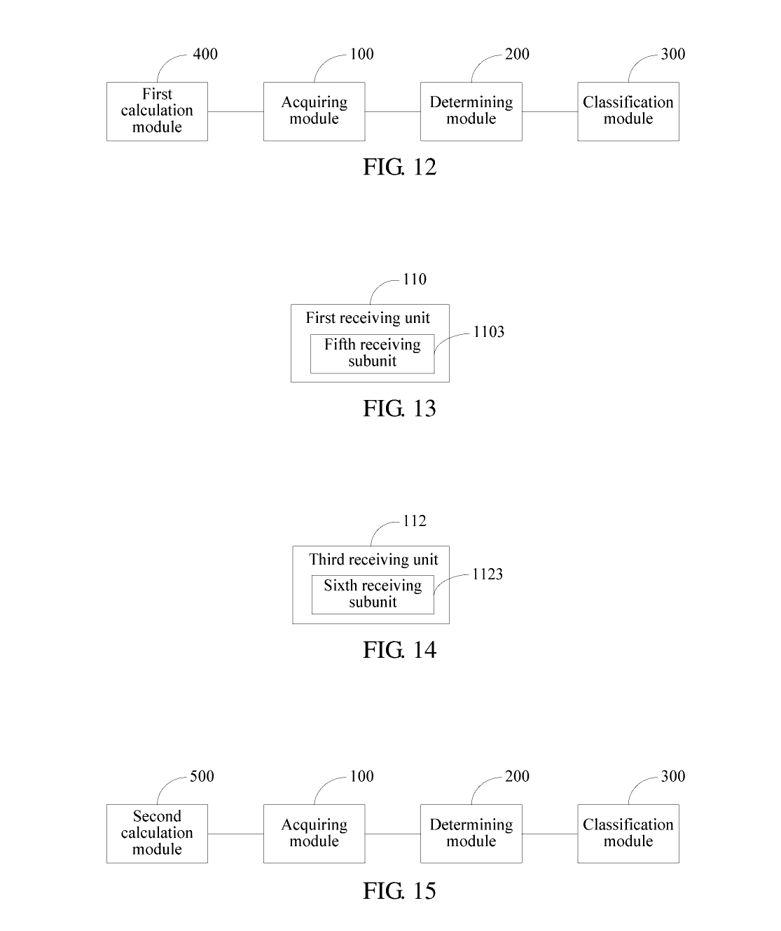

Correspondingly, FIG. 12 shows another optional structure of a user classification apparatus. With reference to FIG. 5 and FIG. 12, the user classification apparatus may further include:

a first calculation module 400, configured to set a value of X; count a total number of function type information sequences acquired by the server when X is used as the preset first time; count a total number of function type information sequences acquired by the server when X+N is used as the preset first time, where N is a duration progressive value; calculate the total number of the function type information sequences acquired when X is used as the preset first time, and a deviation rate of the total number of the function type information sequences acquired when X+N is used as the preset first time; calculate a squared value of the deviation rate; if the squared value is not greater than a preset first value, determine that the set value of X is a value of the preset first time; and if the squared value is greater than the preset first value, increase the value of X according to a set gradient ascent rule, and determine that a corresponding value of X is the value of the preset first time, until the squared value obtained through calculation is not greater than the preset first value.

Optionally, FIG. 13 shows still another optional structure of the first receiving unit 110. The first receiving unit 110 may include:

a fifth receiving subunit 1103, configured to receive, when an option, which is presented by the terminal device to the user, of starting to perform the operation is triggered by the user, the information, which is sent by the terminal device, about starting of the time period in which the user performs the operation; or, receive, when the function of the application is triggered for the first time and after a time during which the function of the application is triggered last time exceeds a preset second time, the information, which is sent by the terminal device, about starting of the time period in which the user performs the operation.

Correspondingly, FIG. 14 shows still another optional structure of the third receiving unit 112. The third receiving unit 112 may include:

a sixth receiving subunit 1123, configured to receive, when one function of the application is triggered, and no next function of the application is triggered in the preset second time, the information, which is sent by the terminal device, about ending of the time period in which the user performs the operation.

Correspondingly, FIG. 15 shows still another optional structure of the user classification apparatus. With reference to FIG. 5 and FIG. 15, the user classification apparatus may further include:

a second calculation module 500, configured to set a value of A; count a total number of the function type information sequences acquired by the server when A is used as the preset second time; count a total number of the function type information sequences acquired by the server when A+n is used as the preset second time, where n is a duration progressive value; calculate the total number of the function type information sequences acquired when A is used as the preset second time, and a deviation rate of the total number of the function type information sequences acquired when A+n is used as the preset second time; calculate a squared value of the deviation rate; if the squared value is not greater than a preset second value, determine that the set value of A is a value of the preset second time; and if the squared value is greater than the preset second value, increase the value of A according to a set gradient ascent rule, and determine that a corresponding value of A is the value of the preset second time, until the squared value obtained through calculation is not greater than the preset second value.

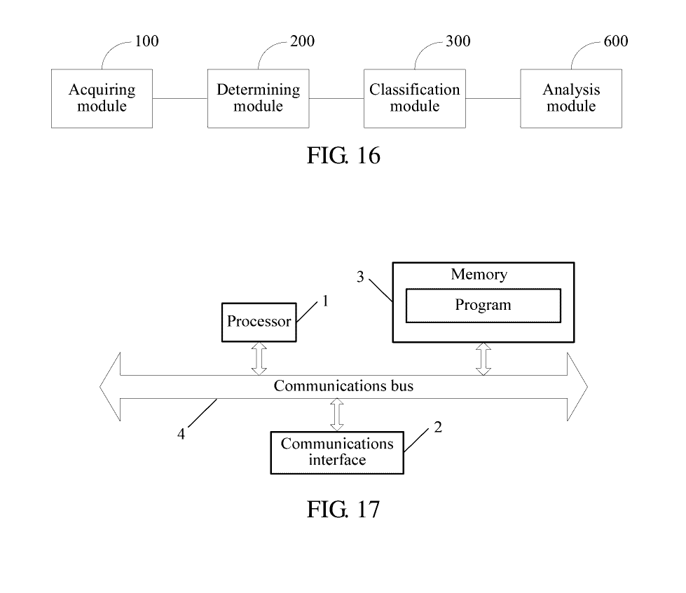

Optionally, FIG. 16 shows yet another optional structure of the user classification apparatus. With reference to FIG. 5 and FIG. 16, the user classification apparatus may further include:

an analysis module 600, configured to acquire, after the users corresponding to the same function type information sequence are classified as the same-class users, and the multiple user classes are formed, feature data of the same-class users, and determine characteristic information of users of different classes.

The number of user classes determined by using the user classification apparatus provided in this embodiment may be classified according to a function type information sequence combined by functions of an application installed in the terminal device operated by a user according to a time sequence, and users corresponding to a same function type information sequence are classified as same-class users, and therefore, a classified user class indicates an operational requirement of users for a same application function, so that the classified user class is very accurate, thereby ensuring a subsequent accurate user data analysis.

An embodiment further provides a server, including the user classification apparatus described above. For description of the user classification apparatus, reference may be made to the foregoing corresponding content, which is not described herein again.

A structure of hardware of the server is described below. FIG. 17 is a structural block diagram of hardware of a server. The server may include: a processor 1, a communications interface 2, a memory 3, and a communications bus 4.

The processor 1, the communications interface 2, and the memory 3 perform mutual communication through the communications bus 4.

Optionally, the communications interface 2 may be an interface of a communications module, such as an interface of a GSM module;

the processor 1 is used for executing a program; and

the memory 3 is used for storing a program, where

the program may include program code, and the program code includes a computer operation instruction.

The processor 1 may be a central processing unit CPU, or an application specific integrated circuit (ASIC), or is configured as one or more integrated circuits implementing this embodiment.

The memory 3 may include a high-speed RAM memory, or may further include a non-volatile memory, such as at a magnetic disk memory.

The program may specifically be used for:

acquiring a function type information sequence uploaded by each terminal device, where one group of function type information sequence corresponds to one terminal device, function type information in each of the function type information sequences is arranged in an order of triggering functions of an application installed in a corresponding terminal device, one piece of function type information is generated after a function of the application is triggered, and the application is a same application installed in each of the terminal devices;

determining a user corresponding to each of the function type information sequences; and

classifying users corresponding to a same function type information sequence as same-class users, to form multiple user classes.

The embodiments in this specification are all described in a progressive manner Description of each of the embodiments focuses on differences from other embodiments, and reference may be made to each other the same or similar parts among respective embodiments. The apparatus disclosed in the embodiments corresponds to the method disclosed in the embodiments and therefore is only briefly described, and reference may be made to the method specification for the associated part.

A person of ordinary skill in the art may further be aware that, in combination with examples described in the embodiments disclosed in this specification, units and algorithm steps can be implemented by electronic hardware, computer software, or a combination thereof. To clearly describe the interchangeability between the hardware and the software, the foregoing has generally described compositions and steps of each example according to functions. Whether the functions are executed by hardware or software depends on specific applications and design constraint conditions of the technical solutions. A person skilled in the art may use different methods to implement the described functions for each specific application, but this implementation should not be considered as going beyond the scope of the present disclosure.

The method or algorithm steps described in the embodiments disclosed in the specification may be directly implemented by using hardware, a software module executed by a processor, or implemented by a combination thereof. The software module may be placed in a random access memory (RAM), a memory, a read-only memory (ROM), an electrically programmable ROM, an electrically erasable programmable ROM, a register, a hard disk, a removable disk, a CD-ROM, or a storage medium in any other form known in the art.

A person skilled in the art can implement or use the present disclosure according to the description of the disclosed embodiments. Multiple modifications to these embodiments are apparent for a person skilled in the art, and a general principle defined in specification may be implemented in other embodiments without departing from the spirit or scope of the present disclosure. Therefore, the claims are not limited to the embodiments described in the specification, but should conform to the widest scope consistent with the principle and novelty disclosed in the specification.

What is claimed is:

1. A user classification method, applied to a server, the server performing data communication with multiple terminal devices, and a same application being installed on the multiple terminal devices; and the method comprising:
acquiring a function type information sequence uploaded by each terminal device, one group of function type information sequence corresponding to one terminal device, function type information in each of the function type information sequences being arranged in an order of triggering functions of an application installed in a corresponding terminal device, and one piece of function type information being generated after one function of the application is triggered;
determining a user corresponding to each of the function type information sequences; and
classifying users corresponding to a same function type information sequence as same-class users, to form multiple user classes.

2. The user classification method according to claim 1, wherein the acquiring a function type information sequence uploaded by each terminal device comprises:
receiving information, which is uploaded by the terminal device, about starting of a time period in which a user performs an operation, wherein one operation performed by the user corresponds to triggering of one function of the application;
receiving, after the function of the application installed in the terminal device is triggered, corresponding function type information uploaded by the terminal device;
receiving information, which is uploaded by the terminal device, about ending of the time period in which the user performs the operation; and
combining the received function type information according to a time sequence in the time period in which the information about starting and the information about ending are received, to obtain the function type information sequence.

3. The user classification method according to claim 2, wherein the receiving information, which is uploaded by the terminal device, about starting of a time period in which a user performs an operation comprises:
receiving, when an option, which is presented by the terminal device to the user, of starting to perform the operation is triggered by the user, the information, which is sent by the terminal device, about starting of the time period in which the user performs the operation; and
the receiving information, which is uploaded by the terminal device, about ending of the time period in which the user performs the operation comprises:
receiving, when an option, which is presented by the terminal device to the user, of ending performing the operation is triggered by the user, the information, which is sent by the terminal device, about ending of the time period in which the user performs the operation.

4. The user classification method according to claim 2, wherein the receiving information, which is uploaded by the terminal device, about starting of a time period in which a user performs an operation comprises:
receiving, when an option, which is presented by the terminal device to the user, of starting to perform the operation is triggered by the user, the information, which is sent by the terminal device, about starting of the time period in which the user performs the operation; or, receiving, when the function of the application is triggered for a first time and after a time during which the function of the application is triggered last time reaches a preset first time, the information, which is sent by the terminal device, about starting of the time period in which the user performs the operation; and
the receiving information, which is uploaded by the terminal device, about ending of the time period in which the user performs the operation comprises:
receiving, when the preset first time is reached after the time period in which the user performs the operation starts, the information, which is sent by the terminal device, of ending of the time period in which the user performs the operation.

5. The user classification method according to claim 4, wherein a process of determining the preset first time comprises:
setting a value of X; counting a total number of function type information sequences acquired by the server when X is used as the preset first time; counting a total number of function type information sequences acquired by the server when X+N is used as the preset first time, wherein N is a duration progressive value; calculating the total number of the function type information sequences acquired when X is used as the preset first time, and a deviation rate of the total number of the function type information sequences acquired when X+N is used as the preset first time; calculating a squared value of the deviation rate; if the squared value is not greater than a preset first value, determining that the set value of X is a value of the preset first time; and if the squared value is greater than the preset first value, increasing the value of X according to a set gradient ascent rule, and determining that a corresponding value of X is the value of the preset first time, until the squared value obtained through calculation is not greater than the preset first value.

6. The user classification method according to claim 2, wherein the receiving information, which is uploaded by the terminal device, about starting of a time period in which a user performs an operation comprises:
receiving, when an option, which is presented by the terminal device to the user, of starting to perform the operation is triggered by the user, the information, which is sent by the terminal device, about starting of the time period in which the user performs the operation; or, receiving, when the function of the application is triggered for a first time and after a time during which the function of the application is triggered last time exceeds a preset second time, the information, which is sent by the terminal device, about starting of the time period in which the user performs the operation; and
the receiving information, which is uploaded by the terminal device, about ending of the time period in which the user performs the operation comprises:
receiving, when one function of the application is triggered, and no next function of the application is triggered in the preset second time, the information, which is sent by the terminal device, about ending of the time period in which the user performs the operation.

7. The user classification method according to claim 1, wherein the acquiring a function type information sequence uploaded by each terminal device comprises:
receiving a combined function type information sequence uploaded by the terminal device, wherein a process in which the terminal device combines the function type information sequence comprises: recording, by the terminal device according to a time sequence when determining a start moment of a time period in which a user performs an operation, the function type information corresponding to the triggered function of the application, and combining, when an end moment of the time period in which the user performs the operation is determined, the function type information recorded according to the time sequence in the time period from the start moment to the end moment, to obtain the function type information sequence, wherein one operation performed by the user corresponds to triggering of one function of the application.

8. The user classification method according to claim 1, wherein the method further comprises:
acquiring, after the users corresponding to the same function type information sequence are classified as the same-class users, and the multiple user classes are formed, feature data of the same-class users, and determining characteristic information of users of different classes.

9. A user classification apparatus, applied to a server, the server performing data communication with multiple terminal devices, and a same application being installed on the multiple terminal devices; and the apparatus comprising:
an acquiring module, configured to acquire a function type information sequence uploaded by each terminal device, one group of function type information sequence corresponding to one terminal device, function type information in each of the function type information sequences being arranged in an order of triggering functions of an application installed in a corresponding terminal device, and one piece of function type information being generated after one function of the application is triggered;
a determining module, configured to determine a user corresponding to each of the function type information sequences; and
a classification module, configured to classify users corresponding to a same function type information sequence as same-class users, to form multiple user classes.

10. The user classification apparatus according to claim 9, wherein the acquiring module comprises:
a first receiving unit, configured to receive information, which is uploaded by the terminal device, about starting of a time period in which a user performs an operation, wherein one operation performed by the user corresponds to triggering of one function of the application;
a second receiving unit, configured to receive, after the function of the application installed in the terminal device is triggered, corresponding function type information uploaded by the terminal device;
a third receiving unit, configured to receive information, which is uploaded by the terminal device, about ending of the time period in which the user performs the operation; and
a combination unit, configured to combine, in the time period in which the information about starting and the information about ending are received, the received function type information according to a time sequence, to obtain the function type information sequence.

11. The user classification apparatus according to claim 10, wherein the first receiving unit comprises:
a first receiving subunit, configured to receive, when an option, which is presented by the terminal device to the user, of starting to perform the operation is triggered by the user, the information, which is sent by the terminal device, about starting of the time period in which the user performs the operation; and
the third receiving unit comprises:
a second receiving subunit, configured to receive, when an option, which is presented by the terminal device to the user, of ending performing the operation is triggered by the user, the information, which is sent by the terminal device, about ending of the time period in which the user performs the operation.

12. The user classification apparatus according to claim 10, wherein the first receiving unit comprises:
a third receiving subunit, configured to receive, when an option, which is presented by the terminal device to the user, of starting to perform the operation is triggered by the user, the information, which is sent by the terminal device, about starting of the time period in which the user performs the operation; or, receive, when the function of the application is triggered for a first time and after a time during which the function of the application is triggered last time reaches a preset first time, the information, which is sent by the terminal device, about starting of the time period in which the user performs the operation; and
the third receiving unit comprises:
a fourth receiving subunit, configured to receive, when the preset first time is reached after the time period in which the user performs the operation starts, the information, which is sent by the terminal device, of ending of the time period in which the user performs the operation.

13. The user classification apparatus according to claim 10, wherein the first receiving unit comprises:
a fifth receiving subunit, configured to receive, when an option, which is presented by the terminal device to the user, of starting to perform the operation is triggered by the user, the information, which is sent by the terminal device, about starting of the time period in which the user performs the operation; or, receive, when the function of the application is triggered for a first time and after a time during which the function of the application is triggered last time exceeds a preset second time, the information, which is sent by the terminal device, about starting of the time period in which the user performs the operation; and
the third receiving unit comprises:
a sixth receiving subunit, configured to receive, when one function of the application is triggered, and no next function of the application is triggered in the preset second time, the information, which is sent by the terminal device, about ending of the time period in which the user performs the operation.

14. The user classification apparatus according to claim 9, wherein the acquiring module comprises:
a fourth receiving unit, configured to receive a combined function type information sequence uploaded by the terminal device, wherein a process in which the terminal device combines the function type information sequence comprises: recording, by the terminal device according to a time sequence when determining a start moment of a time period in which a user performs an operation, the function type information corresponding to the triggered function of the application, and combining, when an end moment of the time period in which the user performs the operation is determined, the function type information recorded according to the time sequence in the time period from the start moment to the end moment, to obtain the function type information sequence, wherein one operation performed by the user corresponds to triggering of one function of the application.

15. The user classification apparatus according to claim 9, further comprising:
an analysis module, configured to acquire, after the users corresponding to the same function type information sequence are classified as the same-class users, and the multiple user classes are formed, feature data of the same-class users, and determine characteristic information of users of different classes.

16. A server, comprising a user classification apparatus, the server performing data communication with multiple terminal devices, and a same application being installed on the multiple terminal devices; and the apparatus comprising:
an acquiring module, configured to acquire a function type information sequence uploaded by each terminal device, one group of function type information sequence corresponding to one terminal device, function type information in each of the function type information sequences being arranged in an order of triggering functions of an application installed in a corresponding terminal device, and one piece of function type information being generated after one function of the application is triggered;
a determining module, configured to determine a user corresponding to each of the function type information sequences; and
a classification module, configured to classify users corresponding to a same function type information sequence as same-class users, to form multiple user classes.

17. The server according to claim 16, wherein the acquiring module comprises:
a first receiving unit, configured to receive information, which is uploaded by the terminal device, about starting of a time period in which a user performs an operation, wherein one operation performed by the user corresponds to triggering of one function of the application;
a second receiving unit, configured to receive, after the function of the application installed in the terminal device is triggered, corresponding function type information uploaded by the terminal device;
a third receiving unit, configured to receive information, which is uploaded by the terminal device, about ending of the time period in which the user performs the operation; and
a combination unit, configured to combine, in the time period in which the information about starting and the information about ending are received, the received function type information according to a time sequence, to obtain the function type information sequence.

18. The server according to claim 17, wherein the first receiving unit comprises:
a first receiving subunit, configured to receive, when an option, which is presented by the terminal device to the user, of starting to perform the operation is triggered by the user, the information, which is sent by the terminal device, about starting of the time period in which the user performs the operation; and
the third receiving unit comprises:
a second receiving subunit, configured to receive, when an option, which is presented by the terminal device to the user, of ending performing the operation is triggered by the user, the information, which is sent by the terminal device, about ending of the time period in which the user performs the operation.

19. The server according to claim 17, wherein the first receiving unit comprises:
a third receiving subunit, configured to receive, when an option, which is presented by the terminal device to the user, of starting to perform the operation is triggered by the user, the information, which is sent by the terminal device, about starting of the time period in which the user performs the operation; or, receive, when the function of the application is triggered for a first time and after a time during which the function of the application is triggered last time reaches a preset first time, the information, which is sent by the terminal device, about starting of the time period in which the user performs the operation; and
the third receiving unit comprises:
a fourth receiving subunit, configured to receive, when the preset first time is reached after the time period in which the user performs the operation starts, the information, which is sent by the terminal device, of ending of the time period in which the user performs the operation.

20. The server according to claim 16, wherein the acquiring module comprises:
a fourth receiving unit, configured to receive a combined function type information sequence uploaded by the terminal device, wherein a process in which the terminal device combines the function type information sequence comprises: recording, by the terminal device according to a time sequence when determining a start moment of a time period in which a user performs an operation, the function type information corresponding to the triggered function of the application, and combining, when an end moment of the time period in which the user performs the operation is determined, the function type information recorded according to the time sequence in the time period from the start moment to the end moment, to obtain the function type information sequence, wherein one operation performed by the user corresponds to triggering of one function of the application.
